(19) United States
(12) Patent Application Publication
(10) Pub. No.: US 2022/0259505 A1
(43) Pub. Date: Aug. 18, 2022

(54) A METHOD FOR CATALYTIC CRACKING OF HYDROCARBONS TO PRODUCE OLEFINS AND AROMATICS WITHOUT STEAM AS DILUENT

(71) Applicant: SABIC GLOBAL TECHNOLOGIES B.V., Bergen op Zoom (NL)

(72) Inventors: Xie PENG, Dalian (CN); Mingzhi LI, Dalian (CN); Zhongmin LIU, Dalian (CN); Haitao LIU, Shanghai (CN); Jinzhe LI, Dalian (CN); Talal Khaled AL-SHAMMARI, Riyadh (SA)

(73) Assignee: SABIC GLOBAL TECHNOLOGIES B.V., Bergen op Zoom (NL)

(21) Appl. No.: 17/626,436

(22) PCT Filed: Jul. 30, 2020
(86) PCT No.: PCT/IB2020/057232

§ 371 Date: Jan. 11, 2022

Related U.S. Application Data
(60) Provisional application No. 62/883,057, filed on Aug. 5, 2019.

(51) Int. Cl. C10G 11/05; B01J 29/08; B01J 29/40; B01J 29/80

(52) U.S. Cl. CPC C10G 11/05; B01J 29/088; B01J 29/405; B01J 29/80; C10G 2400/30; B01J 2229/24; C10G 2300/80; C10G 2300/4006; C10G 2300/4018; C10G 2300/708; C10G 2400/20

(57) ABSTRACT

A method of producing olefins and/or aromatics is disclosed. The method includes catalyzing a hydrocarbon cracking reaction with a catalyst comprising a mixture of ZSM-5 zeolite and USY zeolite modified with lanthanum. The cracking process includes providing a diluent comprising primarily methane to the reactor, wherein steam is not provided to the reactor as a diluent.

### CROSS REFERENCE TO RELATED APPLICATIONS

This application claims the benefit of priority of U.S. Provisional Patent Application No. 62/883,057 filed Aug. 5, 2019, which is hereby incorporated by reference in its entirety.

### FIELD OF INVENTION

The present invention generally relates to the catalytic cracking of hydrocarbons. More specifically, the present invention relates to the catalytic cracking of hydrocarbons, under steam free conditions, to produce olefins and/or aromatics.

### BACKGROUND OF THE INVENTION

Light olefins (ethylene, propylene, and butene) and aromatics (benzene, toluene, and xylene (BTX)) are important base materials for making other chemical products. As a result, a significant portion of the petrochemical industry involves processes for production of these base materials. Presently, light olefins and aromatics are primarily produced by pyrolysis and aromatization of naphtha at high temperature (steam cracking). The steam cracking of hydrocarbons to produce olefins and aromatics is currently well developed, providing high conversion rates and yields of desired olefins and aromatics. However, steam cracking has the disadvantage of high reaction temperature and thereby high energy consumption.

Another technology for producing olefins and aromatics involves catalytic cracking of hydrocarbons over molecular sieve catalysts. The catalytic cracking process is characterized by low reaction temperature (lower than steam cracking by 100 to 200° C.) and high selectivity of the desired olefins and aromatics. However, when molecular sieve (silicon-aluminum skeleton) is used as catalyst, under normal reaction conditions—high temperature with steam as dilution gas—dealumination of the molecular sieve catalyst occurs. This decreases the acid active sites of the molecular sieve catalyst and thereby the catalytic activity of the catalyst. In this scenario, the molecular sieve's catalytic activity decreases gradually and efforts to regenerate the molecular sieve catalyst are largely ineffective. Usually, when catalyst activity decreases, reaction time increases, and coking leads to further catalyst activity decline. This technical problem is a major barrier to the industrialization of catalytic cracking over molecular sieves to produce olefins and aromatics.

### BRIEF SUMMARY OF THE INVENTION

A discovery has been made that provides a solution to at least some of the problems, described above, associated with catalytic cracking of hydrocarbons over molecular sieve catalyst to produce olefins or aromatics. The solution is premised on using steam free, or almost steam free, conditions for the cracking process in the reactor in order to prevent the dealumination of the molecular sieve catalyst.

Embodiments of the invention include a method of producing olefins and/or aromatics. The method includes providing a hydrocarbon feed to a reactor that has, disposed therein, a catalyst comprising a mixture of ZSM-5 zeolite and USY zeolite modified with lanthanum. The method further includes providing a diluent comprising primarily methane to the reactor. In this method, steam is not provided to the reactor as a diluent. In this way, water in the reactor during reaction is 5 wt. % or less. The method further includes contacting a mixture of the hydrocarbon feed and the diluent with the catalyst under reaction conditions sufficient to cause cracking and/or aromatization of compounds in the hydrocarbon feed and thereby producing one or more olefins and/or one or more aromatics.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %,” “vol. %” or “mol. %” refer to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, include any measurable decrease or complete inhibition to achieve a desired result.

The term “effective,” as that term is used in the specification and/or claims, means adequate to accomplish a desired, expected, or intended result.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

The term “primarily,” as that term is used in the specification and/or claims, means greater than any of 50 wt. %, 50 mol. %, and 50 vol. %. For example, “primarily” may include 50.1 wt. % to 100 wt. % and all values and ranges there between, 50.1 mol. % to 100 mol. % and all values and ranges there between, or 50.1 vol. % to 100 vol. % and all values and ranges there between.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 is a system for catalytic cracking of hydrocarbons to produce olefins and/or aromatics, according to embodiments of the invention; and

FIG. 2 is a method for catalytic cracking of hydrocarbons to produce olefins and/or aromatics, according to embodiments of the invention.

### DETAILED DESCRIPTION OF THE INVENTION

A discovery has been made that provides a solution to at least some of the problems associated with catalytic cracking of hydrocarbons over molecular sieve catalyst to produce olefins and/or aromatics. The solution is premised on using steam free dilution gas conditions for the cracking process in the reactor in order to prevent the dealumination of molecular sieve catalyst.

According to embodiments of the invention, hydrogen (H₂), (CH₄), (N₂), carbon dioxide (CO₂) or combinations thereof can be used as dilution gas, instead of steam, for the catalytic cracking reaction of hydrocarbons over molecular sieve catalyst to produce olefins and aromatics. Alternatively, according to embodiments of the invention, the catalytic cracking reaction of hydrocarbons over molecular sieve catalyst to produce olefins and aromatics is carried out without dilution gas. By providing steam free conditions, or almost steam free conditions (recognizing although steam is not added as a diluent, steam may enter the catalytic cracking unit, for example, as minute portions of the hydrocarbon feed stream), the catalytic cracking process can maintain initial catalytic activity for a longer period than conventional processes that use steam as a diluent. The steam free conditions provided by embodiments of the invention avoid dealumination of the molecular sieve catalyst that would occur under conditions in which high temperature is combined with steam. As noted above, when steam and high temperatures exist in a process catalyzed by a molecular sieve catalyst, the molecular sieve catalyst can lose frame aluminum, which decreases the acid active sites of the molecular sieve catalyst and thereby the activity of the catalyst.

As catalyst activity decreases, reaction time increases, and increased coking leads to further catalyst activity decline. In embodiments of the invention, however, performance of the catalyst can completely recover after burning off coke from the catalyst. The method, according to embodiments of the invention, can keep a molecular sieve catalyst performing sufficiently well for at least 370 hours of reaction time. In embodiments of the invention, the catalyst remains in service for at least 300 to 400 hours before it is regenerated. This is an improvement when compared with conventional catalytic cracking processes that use steam as dilution gas because in such situations, the molecular sieve catalyst performs sufficiently well for a maximum of 24 hours. In embodiments of the invention, the target products: ethylene, propylene, butene, and BTX yield, collectively, is as high as 70%. In embodiments of the invention, the yield of olefins and aromatics, collectively, is at least 60%.

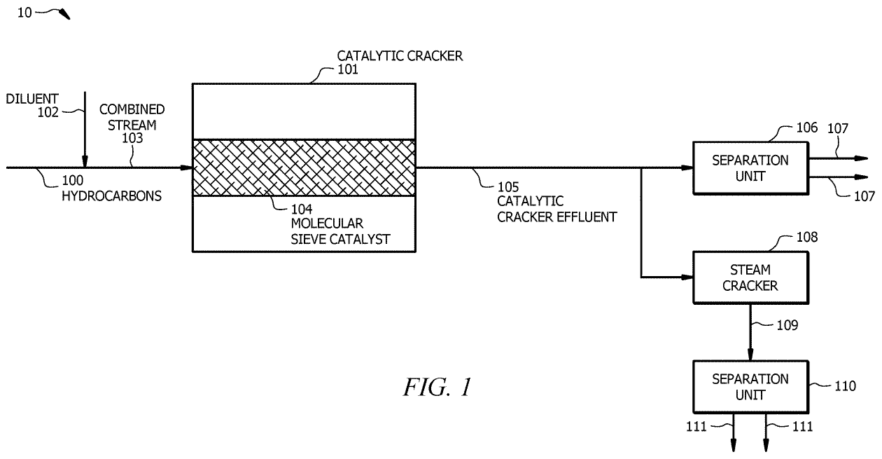

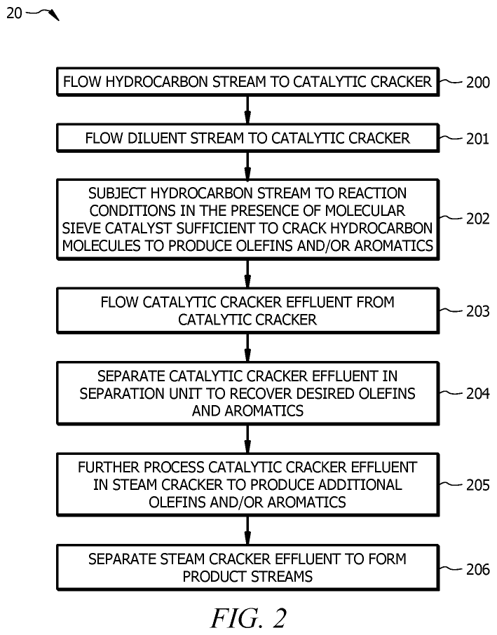

FIG. 1 shows system 10 for catalytic cracking of hydrocarbons to produce olefins and/or aromatics. FIG. 2 shows method 20 for catalytic cracking of hydrocarbons to produce olefins and/or aromatics, according to embodiments of the invention. Method 20 may be implemented using system 10.

Method 20, as implemented by system 10, can include flowing hydrocarbon stream 100 to catalytic cracker 101, at block 200. Hydrocarbon stream 100 may comprise naphtha, gasoline, diesel, and any distilled hydrocarbons or combinations thereof. The naphtha comprised in hydrocarbon stream 100, in embodiments of the invention, includes normal paraffins, iso-paraffins, naphthenes, and aromatics. In embodiments of the invention, hydrocarbon stream 100 comprises C₄ to C₄₀ of any of the following: alkanes, cyclanes, olefins, aromatic compounds, and combinations thereof. In embodiments of the invention, at block 201, diluent stream 102 may also be flowed to catalytic cracker 101. Diluent stream 102 may include a selection from H₂, CH₄, N₂, CO₂, and combinations thereof. As shown in FIG. 1, diluent stream 102 can be mixed with hydrocarbon stream 100 to form combined feed stream 103, which is fed to catalytic cracker 101. Additionally or alternatively, diluent stream 102 may be fed directly catalytic cracker 101, independent of hydrocarbon stream 100 being fed to catalytic cracker 101.

According to embodiments of the invention, catalytic cracker 101 comprises a fixed bed reactor, a fluidized bed reactor, a moving bed reactor, or combinations thereof. According to embodiments of the invention, disposed in catalytic cracker 101 is molecular sieve catalyst 104 adapted to catalyze the cracking of hydrocarbon molecules of hydrocarbon stream 100 to produce olefins and/or aromatics. Molecular sieve catalyst 104, according to embodiments of the invention, includes Si/Al molecular sieve as an active phase, where the structure of frame silicon and aluminum is MFI, Beta, MWW, or MOR; more preferably MFI structure ZSM-5. Molecular sieve catalyst 104, according to embodiments of the invention, may include a mixture of ZSM-5 zeolite and USY zeolite modified with lanthanum, or combinations thereof. In embodiments of the invention the catalyst has a Si to Al ratio by weight of less than 100

Method 20, according to embodiments of the invention, includes, at block 202, subjecting hydrocarbon stream 100 (e.g., as a part of combined feed stream 103) to reaction conditions, in the presence of molecular sieve catalyst 104, sufficient to crack hydrocarbon molecules of hydrocarbon stream 100 to produce olefins such as ethylene, propylene, and butene and/or aromatics such as benzene, xylene, and toluene. According to embodiments of the invention, the reaction conditions for the catalytic cracking reaction include a temperature in a range of 550 to 750° C. and all ranges and values there between including ranges of 550 to 575° C., 575 to 600° C., 600 to 625° C., 625 to 650° C., 650 to 675° C., 675 to 700° C., 700 to 725° C., and 725 to 750° C. According to embodiments of the invention, the reaction conditions for the catalytic cracking reaction include a pressure in a range of 0.5 to 1.5 atm. According to embodiments of the invention, the reaction conditions for the catalytic cracking reaction include a LHSV in a range of 0.5 to 5 h⁻¹ and all ranges and values there between including ranges of 0.5 to 1.0 h⁻¹, 1.0 to 1.5 h⁻¹, 1.5 to 2.0 h⁻¹, 2.0 to 2.5 h⁻¹, 2.5 to 3.0 h⁻¹, 3.0 to 3.5 h⁻¹, 3.5 to 4.0 h⁻¹, 4.0 to 4.5 h⁻¹, and 4.5 to 5.0 h⁻¹. According to embodiments of the invention, the reaction conditions for the catalytic cracking reaction include a ratio of dilution gas (m³) to feedstock (kg) of 0 to 10 m³/kg and all ranges and values there between including ranges of 0 to 1 m³/kg, 1 to 2 m³/kg/2 to 3 m³/kg, 3 to 4 m³/kg, 4 to 5 m³/kg, 5 to 6 m³/kg, 6 to 7 m³/kg, 7 to 8 m³/kg, 8 to 9 m³/kg and 9 to 10 m³/kg.

Method 20, according to embodiments of the invention, includes, at block 203, flowing catalytic cracker effluent 105 from catalytic cracker 101. According to embodiments of the invention, catalytic cracker effluent 105 comprises 10 to 25 wt. % ethylene, 20 to 30 wt. % propylene, 5 to 10 wt. % butene, 4 to 15 wt. % benzene, 5 to 20 wt. % toluene, and 5 to 12 wt. % xylene.

In embodiments of the invention, catalytic cracker effluent 105 may be separated in separation unit 106 to recover the olefins and aromatics desired in streams 107, at block 204. Additionally or alternatively, catalytic cracker effluent 105 may be processed further to produce additional olefins and/or aromatics, at block 205. Streams 107 may comprise a first stream having primarily C₂ to C₅ olefins and aromatics, a second stream having primarily C₂ to C₄ olefins, third stream having primarily C₂ and C₃. For example, catalytic cracker effluent 105 may be fed to steam cracker 108 to undergo steam cracking to produce steam cracker effluent 109. Reaction conditions for the steam cracking include a temperature in a range of 780 to 870° C. and all ranges and values there between including ranges of 780 to 790° C., 790 to 800° C., 800 to 810° C., 810 to 820° C., 820 to 830° C., 830 to 840° C., 840 to 850° C., 850 to 860° C. and 860 to 870° C. According to embodiments of the invention, the reaction conditions for the steam cracking include a pressure in a range of 0.5 bars to 1.5 bars. According to embodiments of the invention, the reaction conditions for the steam cracking reaction include a LHSV in a range of 0.5 to 2.5 h⁻¹. According to embodiments of the invention, the reaction conditions for the steam cracking reaction include a ratio of dilution gas (m³) to feedstock of (kg) 0 to 10 m³/kg and all ranges and values there between including ranges of 0 to 1 m³/kg, 1 to 2 m³/kg/2 to 3 m³/kg, 3 to 4 m³/kg, 4 to 5 m³/kg, 5 to 6 m³/kg, 6 to 7 m³/kg, 7 to 8 m³/kg, 8 to 9 m³/kg and 9 to 10 m³/kg.

In embodiments of the invention, steam cracker effluent 109 comprises 20 to 30 wt. % ethylene, 30 to 40 wt. % propylene, 5 to 10 wt. % butene, and 5 to 10 wt. % BTX (benzene, toluene, and xylene). At block 206, embodiments of the invention may include separating steam cracker effluent 109 by separation unit 110 to form product streams 111.

Although embodiments of the present invention have been described with reference to blocks of FIG. 2, it should be appreciated that operation of the present invention is not limited to the particular blocks and/or the particular order of the blocks illustrated in FIG. 2. Accordingly, embodiments of the invention may provide functionality as described herein using various blocks in a sequence different than that of FIG. 2.

### EXAMPLES

As part of the disclosure of the present invention, specific examples are included below. The examples are for illustrative purposes only and are not intended to limit the invention. Those of ordinary skill in the art will readily recognize parameters that can be changed or modified to yield essentially the same results.

In the examples of this application, the yield and selectivity are calculated based on mass. The fixed bed uses molecular sieve catalyst having lanthanum and phosphorus-modified ZSM-5 zeolite in hydrogen form, and the fluidized bed uses molecular sieve catalyst having

LaZSM-5 mixed with USY. The reaction of olefin and aromatic hydrocarbons is catalyzed by hydrocarbon compounds in a steam-free atmosphere.

TABLE 1
Classified Feedstock-Naphtha

| | Normal | | Naphthenic | Aromatic |
|---|---|---|---|---|
| | Paraffin | Iso-paraffin | species | Species |
| | content | content | content | content |
| Feedstock | (wt. %) | (wt. %) | (wt. %) | (wt. %) |
| Naphtha | 41.04 | 24.23 | 15.26 | 14.49 |

### Example 1

### The Catalytic Cracking of Naphtha Using H₂ as Diluted Gas

Reaction conditions for Example 1 include a reaction temperature of 630 to 670° C., a raw material space velocity of 1.2 h⁻¹, and a gas oil ratio is 0.6 m³/kg.

The results obtained for Example 1 are shown in Table 2. In each recycle period, with the increase of reaction time, the coking amount increases and the activity decreases. The initial activity can be restored after regeneration (burnt in air under 700° C. for 2 hours). In the initial stage, the yield of the target product can reach 70%. The way of controlling the reaction temperature affects the yield and the length of time of the single operation period.

TABLE 2
Yield of Products in 8 Recycle Period Using H₂ as Diluted Gas

| | Recycle No. | | | | | | | |
|---|---|---|---|---|---|---|---|---|
| | 1 | 2 | 3 | 4 | 5 | 6 | 7 | 8 |
| | Reaction time, hour | | | | | | | |
| | 30.5 | 34.6 | 35 | 21.7 | 23.2 | 30.5 | 109.9 | 76.9 |
| Products | Average yield (wt. %) | | | | | | | |
| CH₄ | 6.29 | 5.58 | 5.54 | 6.59 | 6.44 | 4.65 | 3.78 | 4.45 |
| C₂H₆ | 5.04 | 4.41 | 4.24 | 5.02 | 4.80 | 3.94 | 3.22 | 3.30 |
| C₂H₄ | 14.18 | 13.85 | 13.79 | 14.74 | 14.93 | 13.07 | 10.54 | 12.54 |
| C₃H₈ | 4.43 | 4.42 | 4.15 | 4.37 | 4.27 | 4.98 | 4.23 | 4.52 |
| C₃H₆ | 15.83 | 18.07 | 18.18 | 17.10 | 18.27 | 17.96 | 17.81 | 18.90 |
| C₄H₁₀ | 1.90 | 2.31 | 2.16 | 1.78 | 1.88 | 2.65 | 2.65 | 2.70 |
| C₄H₈ | 4.09 | 5.13 | 5.21 | 4.39 | 4.85 | 5.62 | 6.28 | 5.84 |
| C₅ | 1.05 | 1.21 | 1.20 | 1.03 | 1.11 | 1.38 | 1.61 | 1.37 |
| C₆₊ | 21.70 | 20.72 | 21.64 | 18.01 | 17.57 | 21.89 | 29.09 | 22.94 |
| Benzene | 8.24 | 7.62 | 7.55 | 9.38 | 8.97 | 7.19 | 5.91 | 7.14 |
| Toluene | 10.30 | 9.74 | 9.42 | 10.76 | 10.26 | 9.74 | 8.11 | 9.20 |
| Xylene | 6.95 | 6.93 | 6.92 | 6.83 | 6.66 | 6.93 | 6.76 | 7.11 |
| C₂H₄ + C₃H₆ | 30.01 | 31.92 | 31.97 | 31.84 | 33.20 | 31.03 | 28.35 | 31.44 |
| C₂H₄ + C₃H₆ + C₄H₈ | 34.10 | 37.05 | 37.19 | 36.23 | 38.05 | 36.65 | 34.64 | 37.27 |
| BTX | 25.49 | 24.29 | 23.89 | 26.97 | 25.88 | 23.86 | 20.78 | 23.45 |
| C₂H₄ + C₃H₆ + C₄H₈ + BTX | 59.59 | 61.35 | 61.08 | 63.20 | 63.93 | 60.51 | 55.42 | 60.72 |

### Example 2

### The catalytic Cracking of Naphtha Using H₂+CH₄ as Diluted Gas

Reaction conditions for Example 2 include a reaction temperature of 630 to 660° C., a raw material space velocity is 1.2 h⁻¹, a gas oil ratio of 0.83 m³/kg, and H₂:CH₄=1:1. The results for Example 2 are shown in Table 3.

TABLE 3
Yield of Products Using H₂ + CH₄ as Diluted Gas

| | | | | | |
|---|---|---|---|---|---|
| Reaction time (hour) | 0.5 | 2.1 | 3.7 | 5.3 | 6.9 |
| Temperature (° C.) | 630 | 630 | 640 | 650 | 660 |
| CH₄ | 7.23 | 7.56 | 7.66 | 8.09 | 8.47 |
| C₂H₆ | 4.54 | 3.88 | 3.91 | 3.99 | 4.05 |
| C₂H₄ | 18.65 | 16.46 | 16.84 | 17.19 | 17.45 |
| C₃H₈ | 5.02 | 4.89 | 4.62 | 4.34 | 4.05 |
| C₃H₆ | 18.61 | 18.91 | 19.16 | 19.15 | 18.90 |
| C₄H₁₀ | 2.18 | 2.77 | 2.42 | 2.08 | 1.74 |
| C₄H₈ | 5.08 | 5.60 | 5.37 | 5.02 | 4.57 |
| C₅ | 1.82 | 2.42 | 2.09 | 1.79 | 1.52 |
| C₆₊ | 14.58 | 14.50 | 13.40 | 12.64 | 12.07 |
| Benzene | 7.50 | 8.05 | 9.00 | 9.81 | 10.75 |
| Toluene | 9.41 | 9.47 | 9.89 | 10.21 | 10.64 |
| Xylene | 5.37 | 5.51 | 5.64 | 5.70 | 5.78 |
| C₂H₄ + C₃H₆ | 37.26 | 35.37 | 36.00 | 36.35 | 36.35 |
| C₂H₄ + C₃H₆ + C₄H₈ | 42.34 | 40.96 | 41.37 | 41.37 | 40.92 |
| BTX | 22.28 | 23.02 | 24.53 | 25.71 | 27.17 |
| C₂H₄ + C₃H₆ + C₄H₈ + BTX | 64.62 | 63.98 | 65.90 | 67.09 | 68.09 |

### Example 3

### The Catalytic Cracking of Naphtha Using CH₄ as Diluted Gas

Reaction conditions for Example 3 includes a reaction temperature 630 to 660° C., a raw material space velocity is 1.2 h⁻¹, and a gas oil ratio of 0.6 m³/kg.

The reaction results for Example 3 are shown in Table 4.

TABLE 4
Yield of Products Using CH₄ as Diluted Gas

| | | | | | |
|---|---|---|---|---|---|
| Reaction time (hour) | 0.5 | 2.1 | 3.7 | 5.3 | 6.9 |
| Temperature (° C.) | 630 | 630 | 640 | 650 | 660 |
| CH₄ | 2.22 | 5.93 | 7.43 | 8.41 | 8.67 |
| C₂H₆ | 3.44 | 3.46 | 3.54 | 3.66 | 3.72 |
| C₂H₄ | 14.80 | 15.16 | 15.84 | 16.59 | 16.94 |
| C₃H₈ | 4.87 | 4.88 | 4.65 | 4.45 | 4.19 |
| C₃H₆ | 15.93 | 17.10 | 17.69 | 18.23 | 18.33 |
| C₄H₁₀ | 2.25 | 2.44 | 2.21 | 1.97 | 1.73 |
| C₄H₈ | 4.63 | 5.05 | 4.95 | 4.81 | 4.56 |
| C₅ | 2.04 | 2.31 | 2.09 | 1.88 | 1.70 |
| C₆₊ | 23.13 | 19.06 | 16.24 | 13.24 | 12.70 |
| Benzene | 7.71 | 7.99 | 8.74 | 9.62 | 10.21 |
| Toluene | 11.48 | 10.48 | 10.61 | 11.01 | 11.14 |
| Xylene | 7.52 | 6.12 | 6.01 | 6.13 | 6.10 |
| C₂H₄ + C₃H₆ | 30.72 | 32.26 | 33.53 | 34.82 | 35.27 |
| C₂H₄ + C₃H₆ + C₄H₈ | 35.35 | 37.31 | 38.48 | 39.62 | 39.83 |
| BTX | 26.70 | 24.60 | 25.36 | 26.76 | 27.46 |
| C₂H₄ + C₃H₆ + C₄H₈ + BTX | 62.06 | 61.91 | 63.84 | 66.39 | 67.28 |

### Example 4

### The Catalytic Cracking of Naphtha Using CO₂ as Diluted Gas

Reaction conditions for Example 4 include a reaction temperature 630 to 660° C., a raw material space velocity of 1.2 h⁻¹, and a gas oil ratio is 0.6 m³/kg.

The reaction results for Example 4 are shown in Table 5.

TABLE 5
Yield of Products Using CO₂ as Diluted Gas

| | | | | | |
|---|---|---|---|---|---|
| Reaction time (hour) | 0.5 | 2.1 | 3.7 | 5.3 | 6.9 |
| Temperature (° C.) | 630 | 630 | 640 | 650 | 660 |
| CH₄ | 3.83 | 3.66 | 4.00 | 4.40 | 4.81 |
| C₂H₆ | 4.81 | 4.63 | 4.67 | 4.70 | 4.64 |
| C₂H₄ | 18.70 | 17.48 | 17.52 | 17.48 | 17.30 |
| C₃H₈ | 5.45 | 5.25 | 4.85 | 4.48 | 4.08 |
| C₃H₆ | 18.82 | 19.38 | 19.85 | 20.15 | 20.52 |
| C₄H₁₀ | 2.31 | 2.56 | 2.39 | 2.21 | 2.08 |
| C₄H₈ | 5.40 | 5.78 | 5.72 | 5.58 | 5.49 |
| C₅ | 2.93 | 3.57 | 3.40 | 3.18 | 3.16 |
| C₆₊ | 19.16 | 20.17 | 19.60 | 19.00 | 18.55 |
| Benzene | 4.88 | 4.57 | 5.01 | 5.63 | 6.21 |
| Toluene | 8.57 | 8.03 | 8.17 | 8.41 | 8.43 |
| Xylene | 5.15 | 4.94 | 4.81 | 4.80 | 4.72 |
| C₂H₄ + C₃H₆ | 37.53 | 36.85 | 37.37 | 37.63 | 37.82 |
| C₂H₄ + C₃H₆ + C₄H₈ | 42.93 | 42.63 | 43.08 | 43.21 | 43.31 |
| BTX | 18.60 | 17.54 | 18.00 | 18.83 | 19.37 |
| C₂H₄ + C₃H₆ + C₄H₈ + BTX | 61.53 | 60.17 | 61.08 | 62.04 | 62.68 |

### Example 5

### The Catalytic Cracking of Naphtha Using N₂ as Diluted Gas

Reaction conditions for Example 5 include a reaction temperature 630 to 660° C., a raw material space velocity of 1.2 h⁻¹, and a gas oil ratio of 0.5 m³/kg.

The reaction results for Example 5 are shown in Table 6.

TABLE 6
Yield of Products Using N₂ as Diluted Gas

| | | | | | |
|---|---|---|---|---|---|
| Reaction time (hour) | 0.50 | 2.10 | 3.70 | 5.30 | 6.90 |
| Temperature (° C.) | 650 | 650 | 650 | 650 | 650 |
| CH₄ | 4.44 | 6.01 | 5.87 | 5.65 | 5.30 |
| C₂H₆ | 3.93 | 4.62 | 4.36 | 4.19 | 4.08 |
| C₂H₄ | 15.05 | 17.87 | 16.63 | 15.81 | 14.97 |
| C₃H₈ | 4.28 | 5.13 | 4.78 | 4.52 | 4.30 |
| C₃H₆ | 14.05 | 19.04 | 19.30 | 19.64 | 19.88 |
| C₄H₁₀ | 1.35 | 2.08 | 2.22 | 2.30 | 2.51 |
| C₄H₈ | 3.96 | 5.44 | 5.79 | 5.89 | 6.19 |
| C₅ | 1.33 | 2.00 | 2.35 | 2.70 | 3.28 |
| C₆₊ | 16.93 | 11.96 | 13.50 | 15.66 | 18.10 |
| Benzene | 6.30 | 7.86 | 7.79 | 7.39 | 6.65 |
| Toluene | 14.13 | 11.39 | 10.92 | 10.11 | 9.07 |
| Xylene | 14.25 | 6.61 | 6.50 | 6.14 | 5.67 |
| C₂H₄ + C₃H₆ | 29.10 | 36.90 | 35.94 | 35.44 | 34.84 |
| C₂H₄ + C₃H₆ + C₄H₈ | 33.06 | 42.34 | 41.72 | 41.34 | 41.03 |
| BTX | 34.68 | 25.85 | 25.21 | 23.63 | 21.39 |
| C₂H₄ + C₃H₆ + C₄H₈ + BTX | 67.74 | 68.19 | 66.93 | 64.97 | 62.42 |

### Example 6

### The Catalytic Cracking of Naphtha Using H₂ as Diluted Gas in Fluidized Bed

Reaction conditions for Example 6 includes a reaction temperature 660° C., a raw material space velocity of 1.2 h ⁻¹, a gas oil ratio of 0.42 m³/kg.

The reaction results are shown in Table 7.

TABLE 7
Yield of Products Using H₂ as Diluted Gas in Fluidized Bed Reactor

| | | | | |
|---|---|---|---|---|
| Gas oil ratio (M³/Kg) | 0.42 | 0.42 | 0.42 | 0.42 |
| Space velocity (h⁻¹) | 1.2 | 1.2 | 1.2 | 1.2 |
| Linear velocity (cm/s) | 2.72 | 2.72 | 2.72 | 2.72 |
| Temperature (° C.) | 660 | 660 | 660 | 660 |
| Reaction time (hour) | 0.25 | 1.85 | 3.45 | 5.05 |
| CH₄ | 7.55 | 6.86 | 6.42 | 6.27 |
| C₂H₆ | 5.32 | 4.98 | 4.53 | 4.26 |
| C₂H₄ | 10.45 | 9.82 | 9.55 | 9.38 |
| C₃H₈ | 3.08 | 3.25 | 2.98 | 2.79 |
| C₃H₆ | 8.78 | 11.82 | 13.30 | 14.19 |
| C₄H₁₀ | 0.73 | 1.26 | 1.58 | 1.77 |
| C₄H₈ | 1.85 | 2.44 | 3.99 | 4.81 |
| C₅ | 0.92 | 1.90 | 3.03 | 4.00 |
| C₆₊ | 14.42 | 16.61 | 19.81 | 21.53 |
| Benzene | 19.41 | 15.76 | 13.47 | 11.95 |
| Toluene | 19.91 | 17.62 | 14.79 | 13.00 |
| Xylene | 7.58 | 7.67 | 6.55 | 6.05 |
| C₂H₄ + C₃H₆ | 19.23 | 21.64 | 22.85 | 23.57 |
| C₂H₄ + C₃H₆ + C₄H₈ | 21.08 | 24.08 | 26.84 | 28.38 |
| BTX | 46.90 | 41.06 | 34.81 | 31.00 |
| C₂H₄ + C₃H₆ + C₄H₈ + BTX | 67.97 | 65.13 | 61.65 | 59.38 |

In the context of the present invention, at least the following 12 embodiments are described. Embodiment 1 is a method of producing olefins and/or aromatics. The method includes providing a hydrocarbon feed to a reactor, wherein the reactor has, disposed therein, a catalyst containing a mixture of ZSM-5 zeolite and USY zeolite modified with lanthanum. The method also includes providing a diluent containing primarily methane to the reactor, wherein steam is not provided to the reactor such that water in the reactor is 5 wt. % or less. The method further includes contacting a mixture of the hydrocarbon feed and the diluent with the catalyst under reaction conditions sufficient to cause cracking and/or aromatization of compounds in the hydrocarbon feed and thereby producing one or more olefins and/or one or more aromatics. Embodiment 2 is the method of embodiment 1, wherein the catalyst has a Si to Al ratio by weight of less than 100. Embodiment 3 is the method of either of embodiments 1 or 2, wherein the reaction conditions include a temperature of 550° C. to 750° C. Embodiment 4 is the method of any of embodiments 1 to 3, wherein the diluent further contains one or more of H₂, CH₄, N₂, CO₂. Embodiment 5 is the method of any of embodiments 1 to 4, wherein the hydrocarbon feed includes a selection from the list consisting of: C₄ to C₄₀ alkane, cyclanes, olefin, aromatic compounds, and combinations thereof. Embodiment 6 is the method of any of embodiments 1 to 5, wherein the hydrocarbon feed contains naphtha. Embodiment 7 is the method of any of embodiments 1 to 6, wherein the reactor includes a selection from the list consisting of: a fixed bed reactor, a fluidized bed reactor, a moving bed reactor, and combinations thereof. Embodiment 8 is the method of any of embodiments 1 to 7, wherein the reaction conditions include a LHSV in a range of 0.5 to 5 h⁻¹. Embodiment 9 is the method of any of embodiments 1 to 8, wherein the reaction conditions include a ratio of dilution gas (m³) to feedstock (kg) of 0 to 10 m³/kg. Embodiment 10 is the method of any of embodiments 1 to 9, wherein the catalyst is in service for at least 300 to 400 hours before it is regenerated. Embodiment 11 is the method of any of embodiments 1 to 10, wherein the yield of olefins and aromatics is at least 60%. Embodiment 12 is the method of any of embodiments 1 to 10, wherein the yield of olefins and aromatics is at least 70%.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method of producing olefins and/or aromatics, the method comprising:
providing a hydrocarbon feed to a reactor, wherein the reactor has, disposed therein, a catalyst comprising a mixture of ZSM-5 zeolite and USY zeolite modified with lanthanum;
providing a diluent comprising primarily methane to the reactor, wherein steam is not provided to the reactor such that water in the reactor is 5 wt. % or less; and
contacting a mixture of the hydrocarbon feed and the diluent with the catalyst under reaction conditions sufficient to cause cracking and/or aromatization of compounds in the hydrocarbon feed and thereby producing one or more olefins and/or one or more aromatics.

2. The method of claim 1, wherein the catalyst has a Si to Al ratio by weight of less than 100.

3. The method of claim 1, wherein the reaction conditions comprise a temperature of 550° C. to 750° C.

4. The method of claim 1, wherein the diluent further comprises one or more of H₂, CH₄, N₂, CO₂.

5. The method of claim 1, wherein the hydrocarbon feed comprises a selection from the list consisting of: C₄ to C₄₀ alkane, cyclanes, olefin, aromatic compounds, and combinations thereof.

6. The method of claim 1, wherein the hydrocarbon feed comprises naphtha.

7. The method of claim 1, wherein the reactor comprises a selection from the list consisting of: a fixed bed reactor, a fluidized bed reactor, a moving bed reactor, and combinations thereof.

8. The method of claim 1, wherein the reaction conditions comprise a LHSV in a range of 0.5 to 5 ⁻¹.

9. The method of claim 1, wherein the reaction conditions comprise a ratio of dilution gas (m³) to feedstock (kg) of 0 to 10 m³/kg.

10. The method of claim 1, wherein the catalyst is in service for at least 300 to 400 hours before it is regenerated.

11. The method of claim 1, wherein the yield of olefins and aromatics is at least 60%.

12. The method of claim 1, wherein the yield of olefins and aromatics is at least 70%.

13. The method of claim 3, wherein the yield of olefins and aromatics is at least 70%.

14. The method of claim 4, wherein the yield of olefins and aromatics is at least 70%.

15. The method of claim 5, wherein the yield of olefins and aromatics is at least 70%.

16. The method of claim 6, wherein the yield of olefins and aromatics is at least 70%.

17. The method of claim 7, wherein the yield of olefins and aromatics is at least 70%.

18. The method of claim 8, wherein the yield of olefins and aromatics is at least 70%.

19. The method of claim 9, wherein the yield of olefins and aromatics is at least 70%.

20. The method of claim 10, wherein the yield of olefins and aromatics is at least 70%.
